(19) United States
(12) Patent Application Publication
(10) Pub. No.: US 2025/0069822 A1
(43) Pub. Date: Feb. 27, 2025

(54) SWITCH ACTIVATION MECHANISM

(71) Applicant: Black & Decker, Inc., New Britain, CT (US)

(72) Inventors: Gábor SZOLCSÁNYI, Frankfurt Am Main (DE); Petra MOCIBOV KOEHLER, Wetzlar (DE); Dietmar SAAME, Weiterstadt (DE); NEMETZ Uwe, Hünfelden (DE)

(21) Appl. No.: 18/812,119

(22) Filed: Aug. 22, 2024

(30) Foreign Application Priority Data
Aug. 22, 2023 (EP) 23192793.0

(51) Int. Cl. H01H 3/20; H01H 1/18; H01H 9/06

(52) U.S. Cl. CPC H01H 3/20; H01H 1/18; H01H 9/06; H01H 2009/065

(57) ABSTRACT

A mechanism for operating a switch for a powered device, the mechanism including a first manually operable member and a second manually operable member. The mechanism is configured to activate the switch in response to a first motion and a different second motion of the first manually operable member. The second manually operable member is configured to move in response to the second motion of the first manually operable member.

### CROSS-REFERENCE TO RELATED APPLICATIONS

The present application claims priority to European Patent Application No. EP 23192793.0 filed on Aug. 22, 2023, which is herein incorporated by reference in its entirety.

### FIELD OF THE INVENTION

The present disclosure relates to activation switches for powered devices, such as power tools or garden equipment.

### BACKGROUND OF THE INVENTION

Some power tools include a motor, for example for driving a reciprocating or oscillating load. Such tools are often used to perform compacting tasks such as compacting soil, asphalt or hardcore, or hammering tasks such as breaking up concrete (e.g. a jack hammer). An example of a compacting power tool is a rammer which comprises a reciprocating foot which impacts and flattens the surface to be compacted. A rammer may also be known as a tamper, a soil compactor, a compactor, a jumping jack compactor, a jumping jack tamper. Another example of a compacting power tool is a plate compactor, which is also known as a vibratory plate. Rammers or plate compactors generally comprise an electric motor for driving the reciprocating foot or plate. Battery-operated devices such as rammers and plate compactors commonly have an electric drive that is switched on and off via a switch. Accidental operation of the switch can be dangerous and may result in injury of an operator.

It is desirable for the switch to include a mechanism that prevents accidental operation of the device and that allows the device to be easily deactivated when desired.

### SUMMARY OF THE INVENTION

According to a first aspect, there is provided a mechanism for operating a switch for a powered device, the mechanism comprising a first manually operable member and a second manually operable member, the mechanism being configured to activate the switch in response to a first motion and a different second motion of the first manually operable member, wherein the second manually operable member is configured to move in response to the second motion of the first manually operable member.

The two-stage activation of the switch using the mechanism may prevent the accidental activation of a powered device. This may improve the safety of such devices, particularly devices having heavy or sharp moving components.

The switch may not be activated after the first motion of the first manually operable member. The mechanism may be configured to activate the switch following the second motion of the first manually operable member. The second manually operable member may be configured to directly activate the switch. It may do this by bearing against an actuator of the switch.

The second motion of the first manually operable member may only be achieved after the first motion. This may help to avoid accidental operation of the switch.

The mechanism may be configured to deactivate the switch in response to a deactivation motion of the second manually operable member. The deactivation motion of the second manually operable member may be a translation. The deactivation motion of the second manually operable member may be a single motion. This may allow the switch to be easily deactivated.

The second manually operable member may be configured to move in response to the second motion of the first manually operable member. The second manually operable member may be configured to not move in response to the first motion of the first manually operable member. This may allow the switch to be activated only in response to the second motion, which is performed after the first motion.

The mechanism may be configured to activate the switch in response to movement of the second manually operable member. This may allow the first manually operable member to indirectly activate the switch.

The first motion of the first manually operable member may be a rotation of the first manually operable member. This may help to ensure that the first motion is only performed intentionally by a user.

The second motion of the first manually operable member may be a translation of the first manually operable member. Using a rotation followed by a translation of the first manually operable member to activate the switch may further help to avoid accidental activation of the switch.

The second motion of the first manually operable member may be a translation in a direction perpendicular to an axis about which the first manually operable member is configured to rotate. This may be a convenient mechanism.

The first motion of the first manually operable member may be a translation of the first manually operable member. The first motion of the first manually operable member may be a translation in a different direction to the second motion (if the second motion is also a translation). The use of two different translational motions (for example, requiring the user to push and then slide the first manually operable member) may help to avoid accidental activation of the switch.

The mechanism may be a safety mechanism. The two-stage activation of the switch using the mechanism may reduce the chance of an injury occurring during the use of a powered device incorporating the switch.

The first motion may comprise moving the first manually operable member from a first configuration to a second configuration. The second motion may comprise moving the first manually operable member from the second configuration to a third configuration. The second motion of the first manually operable member may cause the second manually operable member to move from a first, deactivated configuration to a second, activated configuration. The deactivation motion of the second manually operable member may comprise moving the further manually operable member from the activated configuration to the deactivated configuration.

The mechanism may comprise one or more resilient elements configured to bias the first manually operable member towards the first configuration. The mechanism may comprise one or more resilient elements configured to bias the second manually operable member in its deactivated configuration. This may avoid accidental activation by requiring a user to overcome the force of the resilient element to activate the switch.

The second manually operable member may have a lower resistance to motion than the first manually operable member. This may allow the switch to be deactivated more easily compared to activating the switch. This may act as a safety feature.

The first manually operable member may be configured to engage an intermediate member configured to move relative to a housing of the mechanism. The intermediate member may be configured to rotate relative to the housing. The intermediate member may be rotatably connected to the housing. The intermediate member may be contained within the housing.

The intermediate member may be configured to engage the second manually operable member. This may allow motion of the second manually operable member to be driven via the intermediate member.

The intermediate member may be fast with the first manually operable member and/or the second manually operable member. The intermediate member may be integrally formed with the first manually operable member and/or the second manually operable member. This may be convenient for manufacturing of the mechanism.

The intermediate member may be configured to move (for example, rotate) in response to the second motion of the first manually operable member to drive motion of the second manually operable member. This may allow the second manually operable member to be driven in response to the second motion of the first manually operable member.

The switch may comprise a micro switch responsive to motion of the second manually operable member. The micro switch may be activated in response to motion of the second manually operable member. The micro switch may be deactivated in response to the deactivation motion of the second manually operable member. This may allow a power switch circuit of the powered device to be connected to a power supply.

The first manually operable member and the second manually operable member may be fast with each other. The first manually operable member may be configured to move with the second manually operable member. For example, the members may both be attached to a plate, such that motion of the first manually operable member directly causes motion of the second manually operable member. The first manually operable member and the second manually operable member may be formed unitarily. The first manually operable member and the second manually operable member may be integrally formed. This may be convenient for manufacturing of the mechanism.

The switch may be configured to close a power switch circuit that supplies power from a power source to a motor of the powered device. Alternatively, the switch may be configured to send a signal for activating/deactivating the motor of the powered device. This may allow the powered device to be turned on.

According to a further aspect, there is provided a powered device comprising the mechanism of any preceding claim. The device may be a power tool, such as a rammer, or a piece of garden equipment, such as a lawnmower. Such devices may have heavy or sharp moving parts. The mechanism may prevent such devices from being accidentally activated.

The powered device may be a rammer or a plate compacter. The powered device may have a handle. The mechanism may be mounted to the handle.

The powered device may comprise a removable control comprising: the mechanism; and a switch for operation by the mechanism. This may allow the device to be remotely activated and/or deactivated.

The above features may be combined as appropriate, as would be apparent to a skilled person, and may be combined with any of the aspects of the examples described herein.

### BRIEF DESCRIPTION OF THE DRAWINGS

FIG. 1 shows an electric rammer.

FIG. 2 is a cross-section along axis A-A through the rammer of FIG. 1.

FIG. 3 shows a reciprocating drive mechanism and motor control apparatus for use in the rammer of FIGS. 1 and 2.

FIGS. 4(a), 4(b), 4(c) and 4(d) show an example of a mechanism for operating a switch in different stages of activation.

FIG. 4(e) shows an example of the mechanism operating two switches.

FIGS. 5(a) and 5(b) show an alternative implementation of a mechanism for operating a switch.

FIGS. 6(a) and 6(b) illustrate the exterior of a switch unit comprising the mechanism shown in FIGS. 5(a) and 5(b).

FIG. 7 shows a flowchart illustrating the steps of a method of activating and deactivating a powered device.

FIG. 8 shows an example of a powered device having a removable control unit comprising the switch mechanism described herein.

FIG. 9 shows further detail of the removable control unit shown in FIG. 8.

The accompanying drawings illustrate various examples. Common reference numerals are used throughout the figures, where appropriate, to indicate similar features.

### DETAILED DESCRIPTION OF THE DRAWINGS

The following description is presented by way of example to enable a person skilled in the art to make and use the invention. The present invention is not limited to the embodiments described herein and various modifications to the disclosed embodiments will be apparent to those skilled in the art.

The present disclosure describes a rammer by way of example. More generally, the powered device may be any kind of powered device, such as plate compactors, vibratory rollers and lawn mowers.

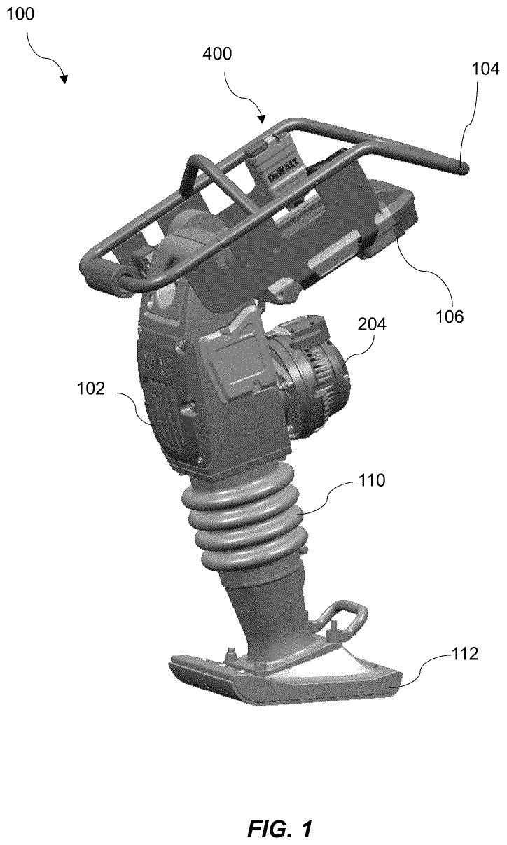

As an example of a power tool, FIG. 1 shows an electric rammer 100 comprising a primary housing 102 and a reciprocating leg portion 110 which is coupled to a compacting foot 112. The compacting foot 112 is adapted for compacting soil, hardcore, asphalt or any other material to be compacted. The reciprocating leg portion comprises a reciprocating mechanism which is arranged to drive the compacting foot up and down along the longitudinal axis of the tool. The rammer includes a handle 104 by which a user can manoeuvre the rammer, and a battery pack interface 106 for removably receiving a battery pack (not shown), which is used for powering the electric motor 204 of the rammer.

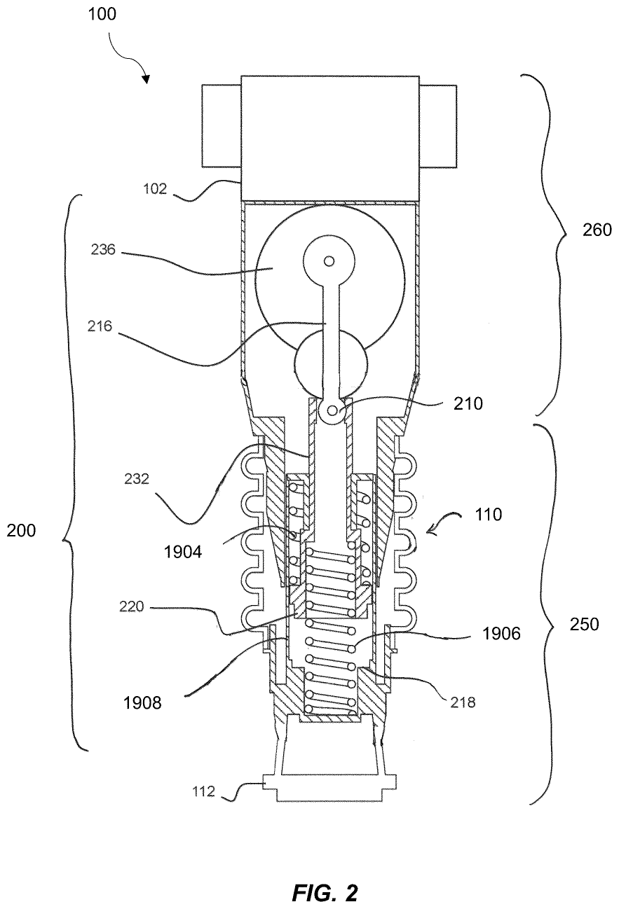

FIG. 2 is a cross-section through the rammer of FIG. 1 and shows the reciprocating mechanism 200 located within the primary housing 102 and reciprocating leg portion 110. The reciprocating mechanism 200 comprises a connecting rod 216 which is connected between an eccentric drive wheel 236 which is driven by an electric motor (not shown in the figure). The connecting rod 216 is configured to move a reciprocating piston 232 between a retracted position where a first end 220 of the reciprocating piston 232 is moved towards the primary housing 102 and an extended position where the first end 220 of the reciprocating piston 232 is moved away from the primary housing 102.

The connecting rod 216 and the reciprocating piston 232 are arranged to move along the longitudinal axis within a piston cylinder 1908. The piston cylinder 1908 receives and guides the movement of the reciprocating piston 232 when moving along the longitudinal axis. The distal end 218 of the piston cylinder 1908, located away from the primary housing 102, is connected to the compacting foot 112 such that movement of the reciprocating mechanism 200 results in movement of the compacting foot 112.

In some examples, the reciprocating piston 232 is coupled to a spring assembly comprising a first spring 1904 and a second spring 1906. When the rammer 100 is not operational, the reciprocating mechanism 200 rests in the position as shown in FIG. 2. This position is dependent on the weight of the rammer and the balance of the upper and lower springs 1904 and 1906 of the spring assembly. The first spring 1904 acts in opposition to movement of the reciprocating piston 232 away from the compacting foot 112 and towards the retracted position. In this way, the first spring 1904 urges the reciprocating piston 232 to towards the compacting foot 112 and the extended position. The second spring 1906 acts in opposition to movement of the reciprocating piston 232 towards the compacting foot 112 and towards the extended position. In this way, the second spring 1906 urges the reciprocating piston 232 away from the compacting foot 112 and towards the retracted position.

The arrangement of springs 1904 and 1906 in FIG. 2 is merely one example. Rammers may in general use any suitable arrangement of one or more biasing elements (e.g. springs, elastomers, dampers, etc.) to control movement of the reciprocating piston 232. The up and down movement of the reciprocating piston 232 along the longitudinal axis due to rotation of the electric motor driving the eccentric drive wheel 236 causes the first and second springs 1904, 1906 alternately expand and compress. Accordingly, the compacting foot 112 reciprocates up and down so as to provide a compacting force to the surface to which the rammer is applied.

The reciprocating leg portion 110 (comprising the piston cylinder 1908 and spring assembly) and the reciprocating foot 112 form a lower mass assembly 250 which reciprocates with respect to an upper mass assembly 260. The upper mass assembly 260 is formed by the remaining components of the rammer 100 in the primary housing 102 (e.g. its motor, eccentric wheel drive, battery pack, etc.). In other words, the lower mass assembly 250 includes those parts of the rammer connected to end 210 of the connecting rod 216 and which therefore move in a reciprocal motion relative to the upper mass assembly 260. The upper mass assembly 260 is in some examples is all the other components which are not part of the lower mass assembly 250.

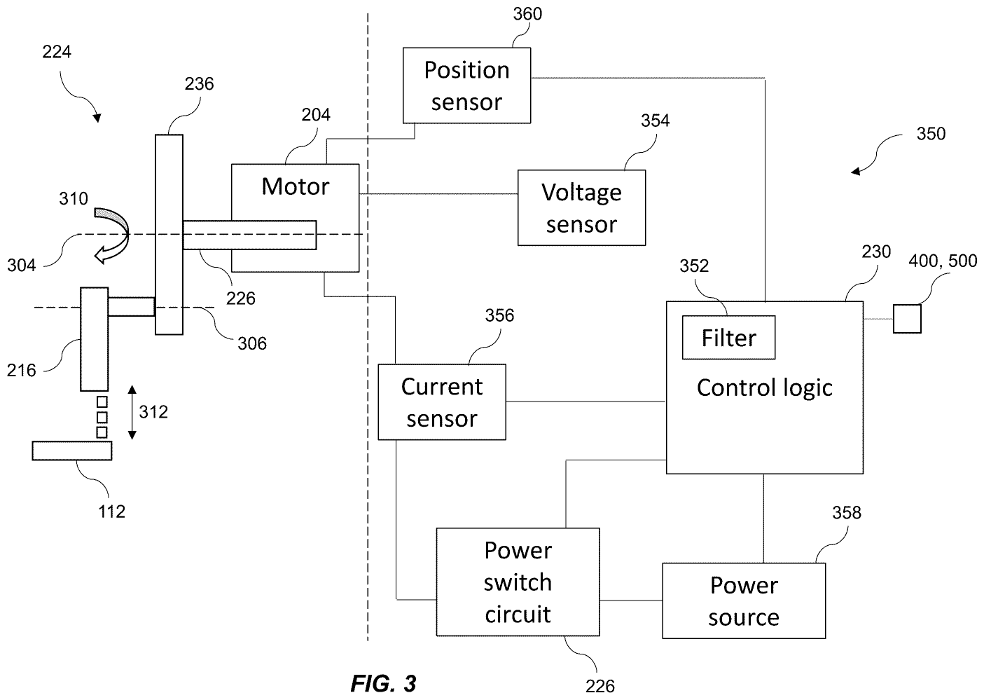

As shown in FIG. 2, the connecting rod 216 is connected between the reciprocating piston 232 and the eccentric drive wheel 236. The eccentric drive wheel 236 is part of a drive mechanism 224 which is shown in cross-section on the left hand side of FIG. 3. The drive mechanism 224 is arranged to generate the reciprocating movement of the lower mass assembly 250 with respect to the upper mass assembly 260. The drive mechanism 224 is rotatably coupled to a drive shaft 226 of an electric motor 204. In FIG. 3, the motor 204 is directly coupled to the eccentric drive wheel 236 but in other examples one or more gears (e.g. a transmission) may be provided between the electric motor 204 and the eccentric drive wheel.

In some examples, the eccentric drive wheel 236 may be coupled to the drive shaft 226 of the motor 204 via a pinion gear mounted on the drive shaft 226 which is arranged to engage with a toothed outer surface (not shown) of the eccentric drive wheel 236 so as to rotate the drive wheel.

Various other mechanical arrangements for converting a rotational movement into a reciprocating movement are known in the art and any suitable such arrangement may be used.

In FIG. 3, the eccentric drive wheel 236 is arranged to rotate about a central axis 304 and the connecting rod 216 is rotatably coupled to the eccentric drive wheel 236 by means of a pin 308. The pin 308 is offset from the central axis 304 of the drive wheel such that rotation 310 of the drive wheel causes the connecting rod to reciprocate up and down 312. In other words, the drive mechanism 224 converts the rotational movement 310 provided by the electric motor 204 into a reciprocating movement 312 for driving the reciprocating mechanism 200.

A brushless direct current (BLDC) motor may be used in which the motor is directly coupled (optionally via a transmission) to a reciprocating mechanism without a clutch (e.g. a centrifugal clutch). In this manner, rotation of the motor corresponds to movement of the reciprocating mechanism and its mechanical load through the reciprocating cycle.

A power source is provided to power the motor 204 and its control apparatus. The power source may be a battery, for example a replaceable battery pack. In order to drive the motor, the control logic is configured to control a power switch circuit which provides voltage and current from the power source to the motor 204 under the control of the control logic. A switch 400, 500 is provided for providing the control logic with an activation or deactivation signal. In alternative embodiments, the switch may be located such that it can open and close the supply of power from the battery to the motor.

The present disclosure describes a mechanism for operating a switch 400, 500 which, in contrast to a conventional switch mechanism, prevents unintentional actuation by means of a two-stage activation and thus acts as a safety mechanism. At the same time, the mechanism can offer the user a high level of comfort.

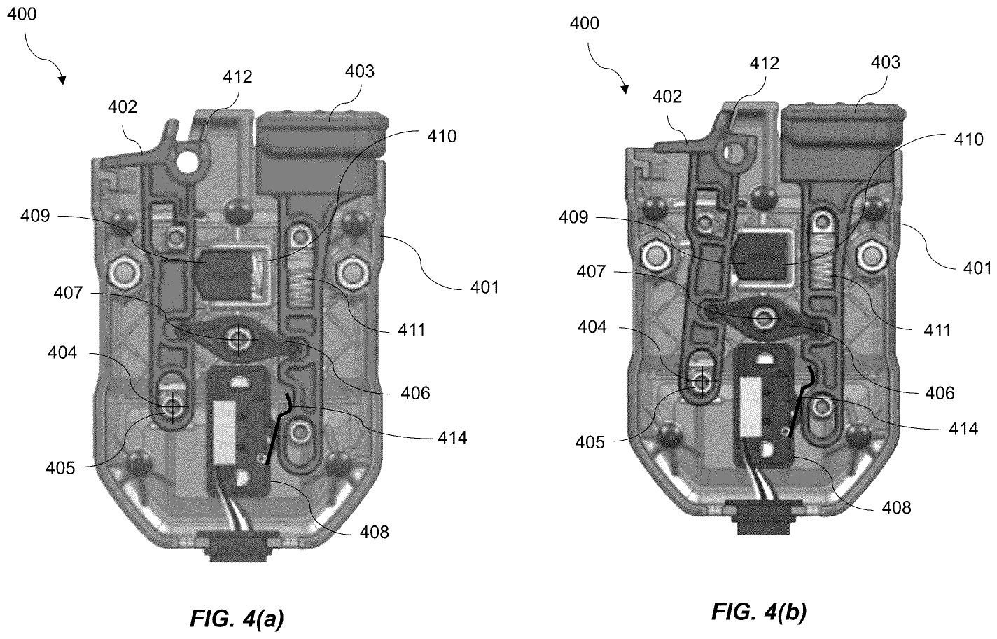

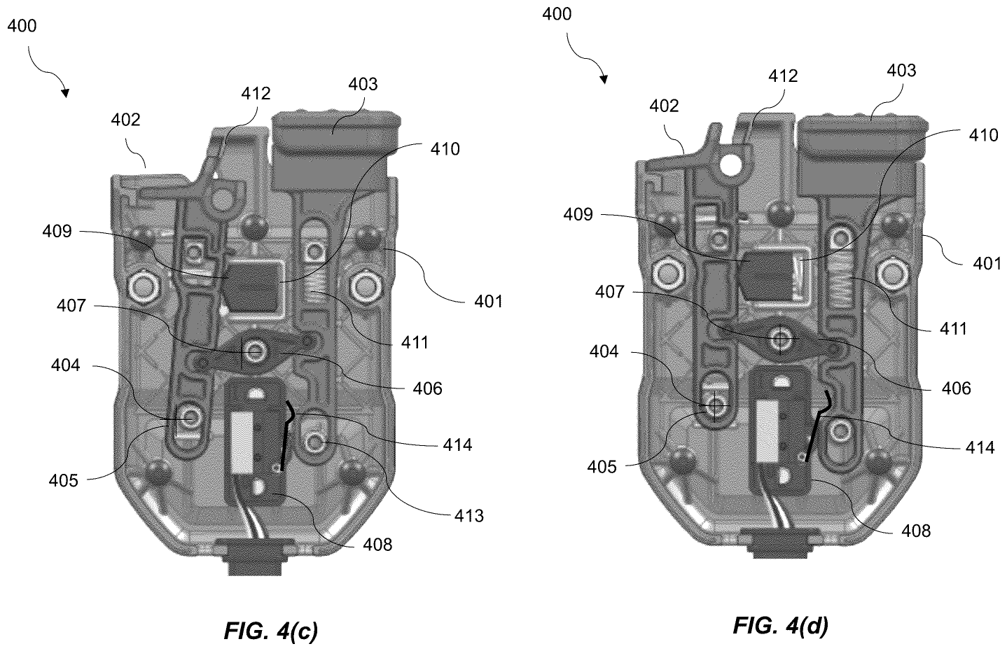

FIGS. 4(a)-4(d) illustrate the operation of a first example of a mechanism for a switch 400. The figures show the mechanism in various stages of its actuation.

Components of the switch are accommodated in a housing 401. Part(s) of some of the components, such as the manually operable members described below, may protrude from the housing so that they can be operated by a user. The manually operable members described herein can be operated by a user without the need for tools (i.e. they may be hand operable). For example, a user may operate a member by applying a force to it with one or more of their fingers, causing the first member 402 to move relative to the housing 401.

In this example, the switch mechanism comprises a manually operable member 402. The manually operable member 402 is a first manually operable member. The mechanism is configured to activate the switch (to send an activation signal to the control logic or to close the circuit that supplies power from the power source to the motor) in response to a first motion and a different second motion of the first manually operable member 402.

The mechanism also comprises a further manually operable member 403. The further manually operable member 403 is a second manually operable member. The mechanism is configured to deactivate the switch (to send a deactivation signal to the control logic or to open the circuit that supplies power from the power source to the motor) in response to a deactivation motion of the second manually operable member 403. The deactivation motion is preferably a single motion.

The first motion of the first member 402 comprises movement of the first member 402 from a first configuration to a second configuration. In this example, the first and second configurations of the first member 402 are shown in FIGS. 4(a) and 4(b) respectively. The second motion comprises movement of the first member from the second configuration to a third configuration. The third configuration of the first member 402 is shown in FIG. 4(c). The first, second and third configurations may be respective positions of the first member 402 relative to the housing 401.

The first and second motions are sequential motions. The second motion follows the first motion. The second motion of the first manually operable member 402 can only be performed after the first motion. For example, the second motion of the first member 402 may only be able to be performed once the first member 402 is in its second configuration, following completion of the first motion.

FIG. 4(a) shows the switch arrangement in the deactivated position, where the first manually operable member is in its first configuration. FIG. 4(b) shows the arrangement after the first motion has been performed, with the first member 402 in its second configuration. In the example shown in FIGS. 4(a)-4(b), the first motion of the first member is a rotation of the member about an axis indicated at 404. The first member rotates about pin 405. The center of pin 405 is coincident with axis 404. The member 402 pivots about the pin 405. The first member moves relative to the housing 401. FIG. 4(b) shows the arrangement when the first manually operable member 402 has completed the first motion. In moving from the first configuration to the second configuration, the first manually operable member rotates about axis 404. Further rotation beyond the second configuration is prevented by a stop 412. Rotation of the first member ceases when it reaches the stop 412, which in this example is part of the housing 401.

In other implementations, the first motion may comprise a different type of motion. For example, the first motion may be a translation of the first manually operable member 402.

In this implementation, the second member 403 does not move in response to the first motion of the first member 402. As shown in FIGS. 4(a) and 4(b), the second member 403 remains in its deactivated configuration throughout the first motion of the first member 402.

The mechanism comprises an intermediate member 406. The intermediate member is configured to engage the first 402 and second 403 members. In this example, the intermediate member 406 is rotatably attached to the housing 401 and rotates about an axis indicated at 407. Protrusions at opposing ends of the intermediate member 406 engage corresponding recesses in the members 402, 403. The intermediate member may not move in response to the first motion of the first member 402. Specifically, the intermediate member may not rotate in response to the first motion of the first member 402. The intermediate member 406 is configured to move in response to the second motion of the first manually operable member 402 to drive motion of the second manually operable member 403. Specifically, the intermediate member 406 is configured to rotate (about axis 407 in this example) in response to the second motion of the first manually operable member 402 to drive motion of the second manually operable member 403.

The mechanism is configured to activate the switch in response to the second motion of the first manually operable member. FIG. 4(c) shows the arrangement when the second motion of the first member 402 has been performed. The first member 402 is now in its third configuration. The second member 403 is now in its activated configuration.

The first member 402 is prevented from moving beyond the third configuration by a stop, for example by the edge of a cut-out in the first member 402 that also allows the first member to pivot about axis 404. The second member may also be prevented from moving beyond its activated configuration by a stop or a catch. In the example shown in FIG. 4(c), a pin 413 fast with the casing 401 which engages with a cut-out in the second member 403 prevents the second member from moving beyond its activated configuration.

The switch arrangement comprises at least one micro switch 408 responsive to motion of the second manually operable member 403. In other words, the second member directly actuates the switch. The first member does not directly actuate the switch, but causes movement of the second member that actuates the switch. In other words, the first member 402 indirectly activates the switch. The second member may be in contact with an actuator 414 of the switch. Movement of the second member from its deactivated configuration to its activated configuration causes the switch to be activated.

A second micro switch may be provided. As shown in FIG. 4(e), the second microswitch has an actuator 414′, which may be provided adjacent to the micro switch 408 and actuator 414. The body of the second micro switch is behind micro switch 408 in FIG. 4(e) so that it's not visible in the figure. The second member (not shown in FIG. 4(e) for clarity purposes) may be in contact with both actuators 414 and 414a. Movement of the second member from its deactivated configuration to its activated configuration causes both the switches to be activated in the same way as switch 414. In this embodiment, one of the micro switches may be for turning on the controller and the other for signalling to start the motor. The switches may be offset by 1 mm so that the microswitch for the controller is switched on first and the microswitch for signalling the start of the motor is switched on just after.

The intermediate member 406 moves in response to the second motion of the first member 402. In this example, the intermediate member 406 rotates in response to the second motion of the first member 402. When the first member 402 moves from its second configuration to its third configuration, the intermediate member rotates about axis 407 and drives the second member 403 to move upwards relative to the housing 401. The rotation of the intermediate member as the first member moves from its second configuration to its third configuration drives the second member 403 to move from its deactivated configuration to its activated configuration. This single motion of the second member causes the activation of micro switch 408. The second member 403 operates an actuator 414 of the micro switch to cause the switch to be activated as it moves from its deactivated configuration to its activated configuration. This can be used indicate to the control logic to activate the powered device or to close the circuit that supplies power from the power source to the motor of the powered device.

In its activated configuration, the second member 403 may protrude from the housing 401. In the example shown in FIG. 4(a), when the switch is deactivated, the second member is flush with the housing, whereas when the switch is activated, the second member protrudes from the housing, as shown in FIG. 4(c). The second motion of the first member therefore causes the second member to ‘pop up’, such that it protrudes further from the housing. As the second member protrudes more from the housing in its second, activated configuration than in its first, deactivated configuration, this makes it more accessible to the user when they want to deactivate the powered device.

In this example, the second motion of the first member 402 is a translation. The second motion is a linear motion. The direction of motion may be at an angle to a longitudinal axis of the housing 401. In this specific example, the second motion is a translation in a direction perpendicular to the axis 404 about which the first manually operable member is configured to rotate.

The second manually operable member 403 is configured to move in response to the second motion of the first manually operable member 402. The mechanism is configured to activate the switch 408 in response to movement of the second manually operable member. In this example, the activation motion of the second member is a translation. The activation motion of the second member is preferably a single motion. The direction of motion may be parallel to the longitudinal axis of the housing. The second member moves between a first configuration and a second configuration to activate the switch. The second motion of the first member causes the activation motion of the second member.

To deactivate the switch, the second member can be moved from the second, activated configuration to return to the first, deactivated configuration. The deactivation motion is preferably a single motion. In this example, the first and second configurations are respective positions of the second member 403 relative to the housing 401 of the switch unit.

FIG. 4(d) shows the arrangement when the switch has been deactivated. The first and second members have returned to their respective first configurations. As a result of the deactivation motion of the second member 403, which in this example is a translation of the second member, the first member 402 has been moved back to its first configuration, via rotation of the intermediate member. The intermediate member 406 is driven to rotate as the single motion moves the second member from its second configuration to its first configuration. In moving from its second configuration to its first configuration, the second member deactivates the micro switch by releasing the actuator 414. This can be used to indicate to the control logic to deactivate the motor of the powered device or to open the circuit that supplies power from the power source to the motor of the powered device.

The mechanism may comprise one or more resilient elements to bias the first manually operable member towards the deactivated position. In this example, the mechanism comprises a pin 409 and a spring 410 which biases the first member towards the first configuration. In FIGS. 4(b) and 4(c), the spring 410 is compressed. The user can overcome the resistance of the spring 410 to move the first member from the first configuration to the second configuration to perform the first motion. Therefore, the first member is configured to resist the first motion. This may further assist in preventing accident activation of the powered device, and thus improve safety.

There may be no added resistance to the second motion (i.e. beyond the inherent resistance of the mechanism). That is, there may not be a resilient element that biases the first member in the second configuration. Therefore, there may be increased resistance to the first motion of the first member, but no increased resistance to the second motion of the first member.

The resilient element acting on the second member resists motion of the second member away from its first, deactivated configuration, and so, via the intermediate member, also acts to resist the second motion of the first member. In some examples, resistance to the second motion of the first member may be provided in this way, without a separate resilient member at the first member for resisting the second motion.

The mechanism may also comprise a further resilient element, such as spring 411, configured to bias the second manually operable member towards the deactivated position (i.e. in its first configuration). When the user presses the second member downwards, to perform the deactivation motion in this example, the spring 411 assists the motion of the second member to deactivate the micro switch. The resilient element therefore biases the second member towards its deactivated configuration.

The second manually operable member 403 may generally have a lower resistance to motion than the first manually operable member 402. This can assist in preventing accidental activation of the powered device.

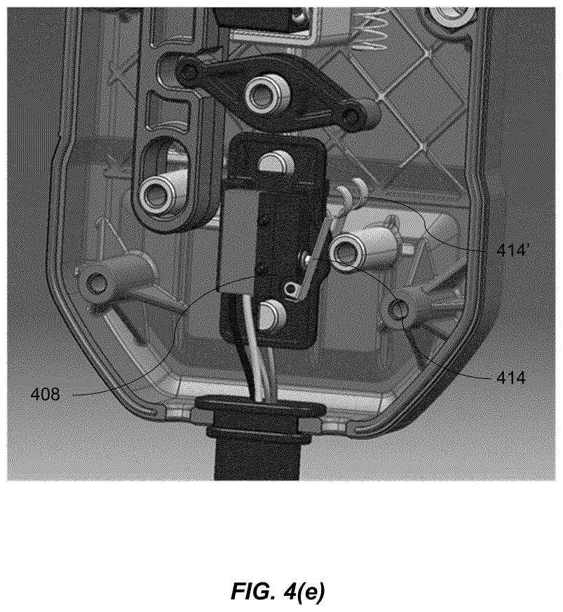

FIGS. 5(a) and 5(b) show a further example of a switch 500. The housing of the switch unit is indicated at 501.

In this example, the mechanism for operating the switch comprises a first manually operable member 502. The mechanism is configured to activate the switch in response to a first motion and a different second motion of the first manually operable member 502.

In this example, the first motion is a translation and the second motion is a translation. The first motion is a translation in a direction perpendicular to the plane of the housing (i.e. the button is pushed into the plane of the housing). The second motion is a translation parallel to the plane of the housing (i.e. the button is slid parallel to the plane of the housing).

The mechanism also comprises a second manually operable member 503. The mechanism is configured to deactivate the switch in response to a deactivation motion of the second manually operable member 503. The single motion is a translation parallel to the plane of the housing. The deactivation motion may be in a direction opposite to that of the second motion of the first member. The deactivation motion is preferably a single motion.

In this example, the first and second members are both fast with a plate 504 that moves within the housing 501 in response to motion of the first 502 and second 503 members. The plate 504 and the first 502 and second 503 members may be integrally formed.

To perform the first motion, a user can push the member 502 into the plane of the housing 501 (either perpendicularly or at an oblique angle). To perform the second motion, the user can slide the member 502 upwards, for example parallel to the plane of the housing, or nearly parallel to the plane of the housing. The switch cannot be activated without both of these push and slide movements. This can prevent accidental activation of the switch.

The arrangement comprises a micro switch 508. Part 509 of the second member (located inside the housing) that is fast with the plate 504 bears against an actuator of the micro switch 508 to activate and deactivate the switch, as described with reference to the previous implementation. As described previously, the first member 502 does not directly activate the micro switch 508. The first and second motions of the first member 502 indirectly activate the switch 508.

The plate 504 comprises a protrusion 505 which protrudes from the plane of the plate 504. The plate cannot move upwards in the housing without the first member 502 being first pushed in to release the protrusion 505 from the stop 506. In this example, the stop 506 is part of the housing 501. The first member 502 is fast with the plate 504. Thus pushing the first member inwards, followed by sliding it upwards, causes the protrusion to be released from the stop and the plate can then move longitudinally in the housing. When the protrusion is against the stop, the second member 503 is in a first, deactivated configuration. Releasing the protrusion from the stop by performing the second motion allows the first member to then move from a second configuration to a third configuration of the first member (i.e. allows the second motion of the first member to be performed).

The protrusion can then slide along the housing until it reaches a detent 507 which retains the protrusion 505 to prevent further upward movement of the plate 504. This retains the second member 503 in a second, activated configuration. When the protrusion is in the detent, the second member 503 may protrude from the housing in its second configuration more than it did in its first configuration. This may allow a user to easily access the second member to deactivate the switch. When the user performs a single first motion on the second member 503, which in this example comprises translating the member 503 by pushing it downwards, the protrusion 505 moves out of the detent 507, and can slide along the interior of the housing until it reaches the stop 506. The protrusion 505 is able to slide along a cam portion on the interior of the housing before passing a lip at an edge of the housing. At this point, the first and second members have been returned to their respective first configurations and the switch is deactivated.

In some examples, the plate may be rigid. In other examples, the plate may not be rigid and may be resiliently deformable. For example, the lower part of the plate may flex to get past the stop 506 and to move into the detent 507 and so only the lower part of the plate may move laterally in response to the first motion of the first member 502.

A resilient element 510 is configured to bias the plate 504 such that motion to either activate or deactivate the switch is resisted. The resilient element may be configured to bias the plate 504 in the activated position (once the second motion of the first member has been performed) and/or the deactivated position (before the first motion of the first member has been performed). In this example, the resilient element 510 is a spring. The resilient element urges the plate towards a wall of the housing. The resilient element biases the plate so as to resist the first motion of the first member. The spring biases the plate so that the protrusion 505 is retained in its initial position against the stop 506 and, when the first and second motions are sequentially performed, retains the protrusion in the detent 507. A user can overcome the force of the resilient element to perform the first motion of the first member 502.

Since the resilient element biases the plate in one direction, and movement of the second member from its second configuration (where the switch is activated) to its first configuration (where the switch is deactivated) occurs in a different direction, the resilient element does not directly oppose movement of the second member so as to deactivate the switch. Thus, the resilient element can resist activation of the switch without acting against movement to deactivate the switch. This arrangement provides a switch that remains easier to turn off, aiding safe operation of the switch.

In the examples described herein, the use of the resilient elements in the mechanism mean that the parts of the mechanism are urged towards respective positions irrespective of gravity. That is, where a tool is at an angle, for example on its side or upside down (which may occur during transport or when the tool is not being used), the mechanism still requires a two-stage activation and cannot be activated as a result of the first member being moved by a combination of gravity and an accidental motion.

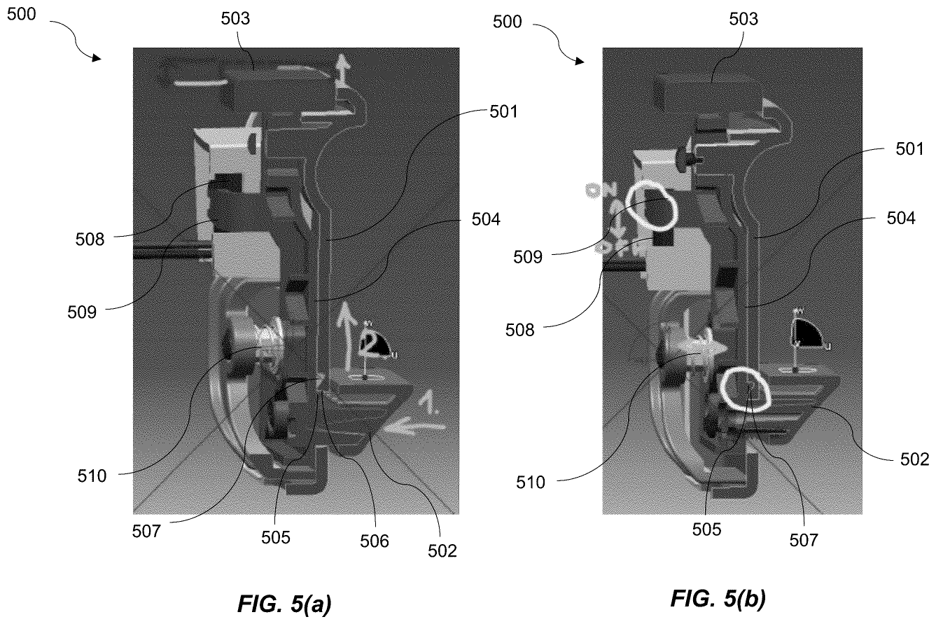

FIGS. 6(a) and 6(b) illustrate external views of a switch unit comprising the mechanism shown in FIGS. 5(a) and 5(b). FIG. 6(a) shows the switch unit in the activated state and FIG. 6(b) shows the switch unit in the deactivated state. As shown in FIG. 6(a), the second member 503 (in its second configuration) protrudes from the housing more than it does in the deactivated state of FIG. 6(b) (in its first configuration). This can allow the user to more easy access the second member 503 to deactivate the switch, which can improve the safety of the mechanism.

The manually operable members may comprise visual indicia. The first manually operable member may comprise a visual indicator to indicate to the user that the first manually operable member is to be used to activate the powered device. For example, the first manually operable member may be coloured green, may display the word ‘ON’ or a line symbol. The second manually operable member may comprise a visual indicator to indicate to the user that the second manually operable member is to be used to deactivate the powered device. For example, the first manually operable member may be coloured red, may display the word ‘OFF’ or a circle symbol.

The first manually operable member may be formed from a green material. In this way, even when the mechanism is worn, the colour green will still be visible (compared, for example, to a surface coating or label that might wear away or peel off). Thus, maintenance of the visual indicator is ensured. Similarly, the second manually operable member may be formed from a red material. The red colour will still be visible to a user even when the mechanism is worn, providing the visual indication to the user.

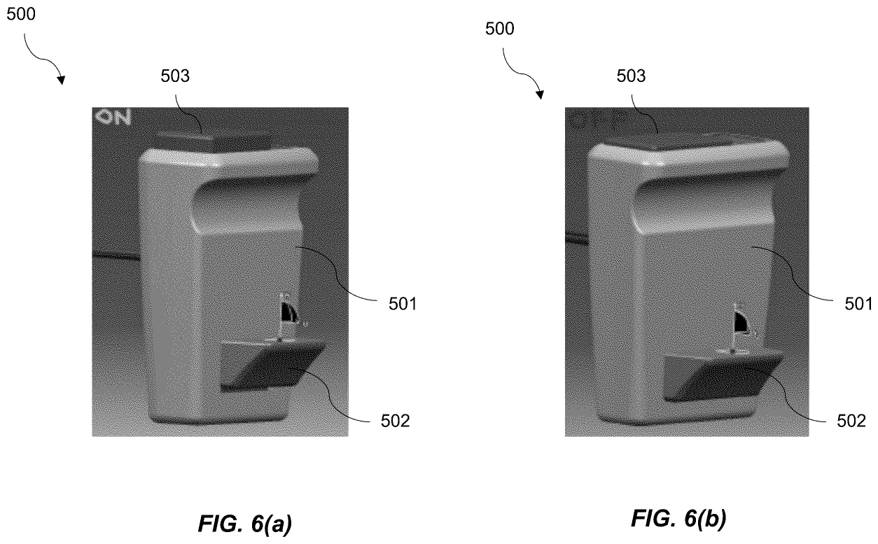

FIG. 7 shows an example of a method of activating and deactivating a powered device featuring the mechanism described herein. At step 701, the method comprises performing a first motion using the first manually operable member. At step 702, the method comprises performing a different second motion using the first manually operable member. The powered device is now activated. At step 703, a task can be performed using the powered device. At step 704, to deactivate the powered device, the method comprises performing a deactivation motion of the second manually operable member.

The switch may be used in any powered device, such as a power tool or a piece of gardening equipment, such as a lawnmower.

The switch mechanism is particularly advantageous when used as part of a tool with heavy or sharp moving parts. The two-stage activation mechanism can prevent accidental activation of the device, which could result in injury of a user. Using a single motion to turn the powered device off also allows the device to be deactivated quickly when desired.

The powered device may be a battery-operated device or a mains-operated device.

For example, the switch may be used as part of a compacting power tool as described with reference to FIGS. 1-3. In such examples, the powered device incorporating the switch may comprise an electric motor and a reciprocating or oscillating drive mechanism coupled to the motor for driving a mechanical load in a reciprocating or oscillating cycle.

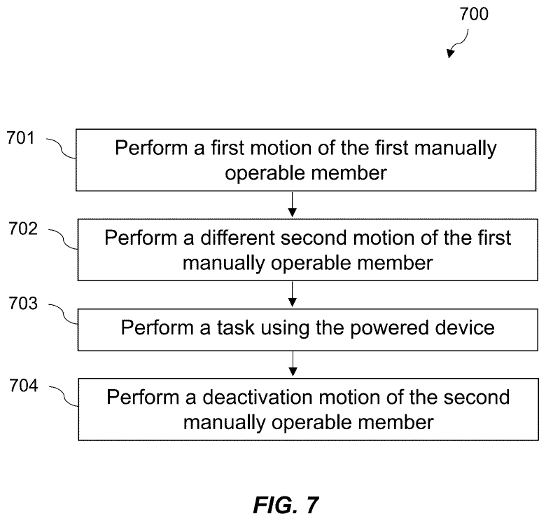

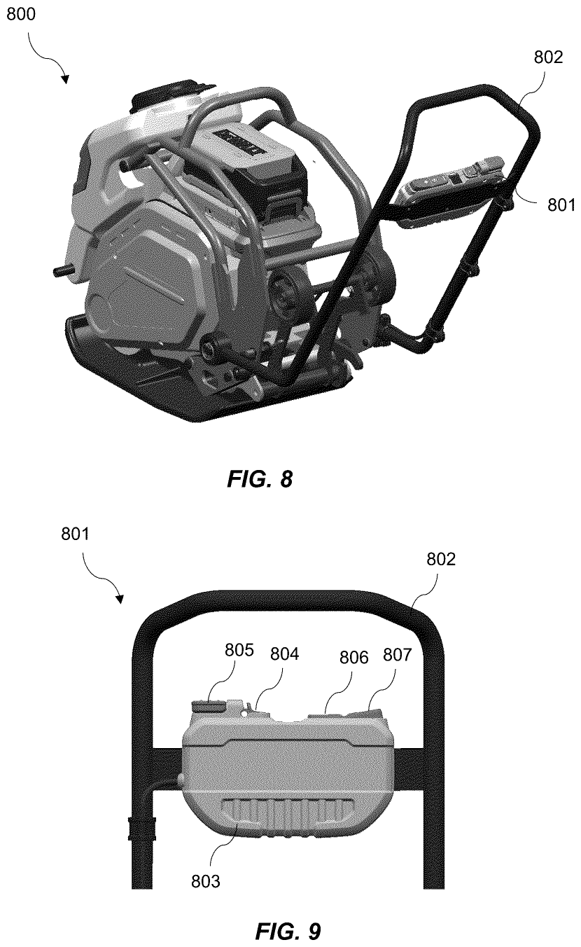

FIG. 8 shows another device 800, which in this example is a plate compactor, which includes the activation switch mechanism described herein. The device 800 may be another type of powered device. As shown in FIGS. 8 and 9, the mechanism may be incorporated into a control switch unit 801 that is removably attached to the powered device. For example, the removable control may be attached to a handle 802 of the powered device. The handle 802 can be removed from the main unit of the device. The control 801 comprises the mechanism and a switch for operation by the mechanism. The housing 803, first manually operable member 804 and second manually operable member 805 are indicated in FIG. 9. In this example, the control switch unit comprises further manually operable members 806 and 807 which are used to control the speed of the device (for example, low and high speed). The members 806 and 807 use a known rocker switch to select speed settings. The mechanism may operate according to any of the implementations described herein.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

We claim:

1. A mechanism for operating a switch for a powered device, the mechanism comprising:
a first manually operable member; and
a second manually operable member,
the mechanism being configured to activate the switch in response to a first motion and a different second motion of the first manually operable member,
wherein the second manually operable member is configured to move in response to the second motion of the first manually operable member.

2. The mechanism as claimed in claim 1, wherein the second motion of the first manually operable member can only be achieved after the first motion.

3. The mechanism as claimed in claim 1, wherein the mechanism is configured to activate the switch in response to movement of the second manually operable member.

4. The mechanism as claimed in claim 1, wherein the mechanism is configured to deactivate the switch in response to a deactivation motion of the second manually operable member.

5. The mechanism as claimed in claim 4, wherein the deactivation motion of the second manually operable member is a translation.

6. The mechanism as claimed in claim 4, wherein the deactivation motion of the second manually operable member is a single motion.

7. The mechanism as claimed in claim 1, wherein the first motion is a rotation of the first manually operable member.

8. The mechanism as claimed in claim 7, wherein the second motion is a translation of the first manually operable member.

9. The mechanism as claimed in claim 8, wherein the second motion is a translation in a direction perpendicular to an axis about which the first manually operable member is configured to rotate.

10. The mechanism as claimed in claim 1, wherein the mechanism comprises one or more further resilient elements configured to bias the second manually operable member towards a deactivated configuration.

11. The mechanism as claimed in claim 1, wherein the second manually operable member has a lower resistance to motion than the first manually operable member.

12. The mechanism as claimed in claim 1, wherein the first manually operable member is configured to engage an intermediate member configured to move relative to a housing of the mechanism.

13. The mechanism as claimed in claim 12, wherein the intermediate member is rotatably connected to the housing.

14. The mechanism as claimed in claim 12, wherein the intermediate member is configured to engage the second manually operable member.

15. The mechanism as claimed in claim 12, wherein the intermediate member is configured to move in response to the second motion of the first manually operable member to drive motion of the second manually operable member.

16. A powered device comprising a mechanism for operating a switch, the mechanism comprising:
a first manually operable member; and
a second manually operable member,
the mechanism being configured to activate the switch in response to a first motion and a different second motion of the first manually operable member,
wherein the second manually operable member is configured to move in response to the second motion of the first manually operable member,
wherein the powered device is a rammer or a plate compacter having a handle, and wherein the mechanism is mounted to the handle.
